(19) United States
(12) Patent Application Publication
(10) Pub. No.: US 2014/0295210 A1
(43) Pub. Date: Oct. 2, 2014

(54) HIGH STRENGTH HOT ROLLED STEEL SHEET AND METHOD FOR PRODUCING THE SAME

(71) Applicant: JFE Steel Corporation, Tokyo (JP)

(72) Inventors: Tamako Ariga, Tokyo (JP); Yoshimasa Funakawa, Tokyo (JP); Noriaki Moriyasu, Tokyo (JP)

(21) Appl. No.: 14/353,380

(22) PCT Filed: Nov. 6, 2012
(86) PCT No.: PCT/JP2012/007089

§ 371 Date: Apr. 22, 2014

(30) Foreign Application Priority Data
Nov. 8, 2011 (JP) 2011-244346

(51) Int. Cl. C22C 38/00; C23C 2/02; C22C 38/28; C22C 38/26; C22C 38/24; C22C 38/16; C22C 38/14; C22C 38/12; C22C 38/10; C22C 38/08; C22C 38/06; C22C 38/04; C22C 38/02; C22C 38/60; B32B 15/01; C21D 8/02

(52) U.S. Cl. CPC C22C 38/00; C21D 8/0263; C23C 2/02; C22C 38/28; C22C 38/26; C22C 38/24; C22C 38/16; C22C 38/14; C22C 38/12; C22C 38/10; C22C 38/08; C22C 38/06; C22C 38/04; C22C 38/02; C22C 38/008; C22C 38/60; C22C 38/002; B32B 15/013
USPC 428/659; 148/602; 148/537; 148/337; 148/332; 148/336; 148/330; 148/333

(57) ABSTRACT

A hot rolled steel sheet includes a composition including: C: 0.03% to less than 0.07%; Si: 0.3% or less; Mn: 0.5% to 2.0%; P: 0.025% or less; S: 0.005% or less; N: 0.0060% or less; Al: 0.1% or less; Ti: 0.07% to 0.11%; and V: 0.08% to less than 0.15% on a mass percent basis, such that Ti and V contents satisfy:

0.18≦Ti+V≦0.24

(where Ti and V are contents of the elements (by mass %)), the balance including Fe and inevitable impurities, a matrix having a ferrite phase with an area ratio of 95% or more; and a structure where fine carbide is dispersedly precipitated in the matrix, the fine carbide containing Ti and V has an average particle size of less than 10 nm, and a volume fraction of the fine carbide is 0.0020 or more, wherein the steel sheet has a tensile strength of 780 MPa or more.

### TECHNICAL FIELD

This disclosure relates to a high strength hot rolled steel sheet suitable for raw material of transportation equipment such as a component for automobiles or a structural material or a similar material, features excellent formability, in particular, excellent stretch-flange formability, material stability, and material uniformity, and has a tensile strength (TS) of 780 MPa or more. The disclosure also relates to a method of producing the high strength hot rolled steel sheet.

### BACKGROUND

From the aspect of global environment conservation, to reduce CO₂ emissions, achieving weight reduction of automobile bodies while maintaining strength to improve fuel consumption of the automobile has been an extremely important problem in the automobile industry. To achieve weight reduction of the automobile bodies while maintaining their strength, it is effective to increase the strength of a steel sheet to be a raw material for automobile components to provide a thinner steel sheet. Therefore, recently, high tensile strength steel sheets have been actively used for automobile components. In the automobile industry, for example, as raw materials for underbody components, application of steel sheets with tensile strength (TS) of 780 MPa level or more has been considered.

On the other hand, most of the automobile components using a steel sheet as raw material are shaped by press processing, burring processing, or similar processing. Therefore, it is required to stably achieve the steel sheet for automobile components having excellent formability (stretch-flange formability). Press forming a steel sheet of partially different strength changes the amount of springback in proportion to the strength, resulting in kinking of components. Accordingly, to obtain components with desired strength and accuracy of dimensions and form, it is extremely important that strength and formability of a steel sheet employed as a raw material be uniform in the width direction of the steel sheet.

Regarding a technique to achieve high strengthening of steel sheet while ensuring excellent formability, for example, Japanese Unexamined Patent Application Publication No. 2006-161112 proposes a technique providing a high strength hot-rolled steel sheet that contains, by mass %, C: 0.08 to 0.20%, Si: 0.001% or more to less than 0.2%, Mn: more than 1.0% to 3.0% or less, Al: 0.001 to 0.5%, V: more than 0.1% to 0.5% or less, Ti: 0.05% or more to less than 0.2%, and Nb: 0.005 to 0.5%, and meets the following three expressions: (Expression 1) (Ti/48+Nb/93)×C./12≦4.5×10⁻⁵, (Expression 2) 0.5 (V/51+Ti/48+Nb/93)/(C./12)≦1.5, and (Expression 3) V+Ti×2+Nb×1.4+C×2+Mn×0.1≧0.80. Balance is Fe and inevitable impurities. The high strength hot-rolled steel sheet has a steel sheet structure where ferrite with an average grain size of 5 μm or less and hardness of 250 Hv or more is contained 70 volume % or more. The high strength hot-rolled steel sheet has a strength of 880 MPa or more and a yield ratio of 0.80 or more.

Japanese Unexamined Patent Application Publication No. 2009-052139 proposes a technique providing a high strength steel sheet that has a chemical composition that contains, by mass %, C: 0.02% or more to 0.20% or less, Si: 0.3% or less, Mn: 0.5% or more to 2.5% or less, P: 0.06% or less, S: 0.01% or less, Al: 0.1% or less, Ti: 0.05% or more to 0.25% or less, V: 0.05% or more to 0.25% or less. Balance is Fe and inevitable impurities. The high strength steel sheet has a substantial ferrite single-phase structure and contains precipitates having a size of less than 20 nm. The precipitates contains 200 mass ppm or more to 1750 mass ppm or less Ti and 150 mass ppm or more to 1750 mass ppm or less V. Solid solution V is 200 mass ppm or more to less than 1750 mass ppm. That technique provides a high strength steel sheet having excellent stretch-flange characteristics after processing and corrosion resistance after painting.

In the technique described in JP '139, a precipitate in a steel sheet is fine-grained (size of less than 20 nm) to enhance strength of the steel sheet. As a precipitate that allows maintaining the precipitate contained in steel sheet to be fine, precipitate containing Ti and V is employed. Additionally, by designing an amount of solid solution V contained in the steel sheet to a desired range, stretch-flange characteristics after processing is improved. That approach results in a high strength hot rolled steel sheet excellent in stretch-flange formability after processing and corrosion resistance after painting and has a tensile strength of 780 MPa or more.

However, in the technique proposed in JP '112, stretch-flange formability is not considered. Accordingly, to ensure a tensile strength of 780 MPa or more, a steel sheet structure is required to be a complex structure of a ferrite phase and a hard phase. However, performing burring processing on a steel sheet with such complex structure, cracks are initiated at interfaces between the ferrite and hard phases. That is, with the technique proposed in JP '112, to ensure a tensile strength of 780 MPa or more, there is a problem that sufficient stretch-flange formability cannot be always obtained. Additionally, controlling the second phase (the hard phase) is difficult. Accordingly, it is extremely difficult to produce a uniform material.

Meanwhile, according to the technique proposed in JP '139, specifying a precipitate of less than 20 nm ensures manufacturing hot-rolled steel sheets featuring excellent formability (elongation and stretch-flange formability) and strength up to about 780 MPa level. However, in strengthening a steel sheet with precipitates, precipitates with finer particle size, which are less than 10 nm, is the main part of the strengthening mechanism. Accordingly, specification of precipitates of less than 20 nm alone cannot obtain sufficient precipitation strengthening. Coexisting precipitates of 20 nm to several nm makes an amount of strengthening with precipitate instable. There is a problem that the strength in a steel sheet width direction does not become uniform.

As described above, with conventional techniques, obtaining high tensile strength steel sheets with stable strength and excellent stretch-flange formability is extremely difficult.

Our steel sheets and methods advantageously solve the problems with the conventional techniques described above. It could therefore be helpful to provide a high strength hot rolled steel sheet and a method of manufacturing the high strength hot rolled steel sheet suitable for transportation equipment and structural materials, in particular automobile components, and has a tensile strength of 780 MPa or more, excellent formability (in particular, stretch-flange formability), and excellent uniformity in strength and formability.

### SUMMARY

We thus provide:
[1] A high strength hot rolled steel sheet includes a chemical composition and a structure (microstructure). The composition consists essentially of: C: 0.03% or more to less than 0.07%; Si: 0.3% or less; Mn: 0.5% or more to 2.0% or less; P: 0.025% or less; S: 0.005% or less; N: 0.0060% or less; Al: 0.1% or less; Ti: 0.07% or more to 0.11% or less; and V: 0.08% or more to less than 0.15% on a mass percent basis, such that Ti and V contents satisfy the following Formula (1). Balance comprises Fe and inevitable impurities. The matrix has a ferrite phase with an area ratio of 95% or more with respect to an overall structure. In the structure, fine carbide is dispersedly precipitated in the matrix, the fine carbide contains Ti and V has an average particle size of less than 10 nm, and a volume fraction of the fine carbide is 0.0020 or more with respect to an overall structure. The high strength hot rolled steel sheet has a tensile strength of 780 MPa or more.

0.18≦Ti+V≦0.24 (1)
(where Ti and V are respective contents of the elements (by mass %)).
[2] In the high strength hot rolled steel sheet according to [1], the chemical composition further contains at least one selected from the group consisting of Nb and Mo by 1% or less in total on a mass percent basis.
[3] In the high strength hot rolled steel sheet according to [1], the chemical composition further contains at least one selected from the group consisting of Cu, Sn, Ni, Ca, Mg, Co, As, Cr, W, B, Pb, Ta, and Sb by 1% or less in total on a mass percent basis.
[4] In the high strength hot rolled steel sheet according to [2], the chemical composition further contains at least one selected from the group consisting of Cu, Sn, Ni, Ca, Mg, Co, As, Cr, W, B, Pb, Ta, and Sb by 1% or less in total on a mass percent basis.
[5] The high strength hot rolled steel sheet according to any one of [1] to [4] further includes a plating layer is formed at a surface of the high strength hot rolled steel sheet.
[6] In the high strength hot rolled steel sheet according to any one of [1] to [4], the high strength hot rolled steel sheet has a hole expansion ratio of 60% or more.
[7] In the high strength hot rolled steel sheet according to [6], a difference in a tensile strength between a center (a center portion) of a sheet width and a position at one-quarter width of the steel sheet is 15 MPa or less, and a difference in a hole expansion ratio among the positions is 15% or less.
[8] A method of producing a high strength hot rolled steel sheet includes: preparing, hot-rolling, cooling, and coiling. The preparing prepares a steel material with a chemical composition according to any one of [1] to [4]. The hot-rolling hot-rolls the steel material including rough rolling and finish rolling at a rolling temperature of 880° C. or more to form a hot-rolled steel sheet. The cooling cools the hot-rolled steel sheet at an average cooling rate of 10° C./sec. or more subsequent to completion of the finish rolling. The coiling coils the hot-rolled steel sheet at 550° C. or more to less than 700° C. The high strength hot rolled steel sheet has a tensile strength of 780 MPa or more.
[9] The method according to [8] further includes plating a surface of the hot-rolled steel sheet subsequent to the coiling.

We provide a high strength hot rolled steel sheet with excellent formability, a strength of tensile strength of 780 MPa or more, and excellent material stability. The high strength hot rolled steel sheet suitable for a raw material for automobile components with a complicated cross-sectional shape when pressing can be stably produced industrially and provides an industrially useful effect.

### DETAILED DESCRIPTION

Hereinafter, our steel sheets and methods will be described in detail.

We investigated various factors affecting high strengthening and formability such as stretch-flange formability of a hot-rolled steel sheet and material stability in a width direction of the hot-rolled steel sheet to solve the above problems. As a result, we discovered the following:
1) Designing the steel sheet structure to have a ferrite single-phase structure with low dislocation density and excellent formability and further precipitation strengthening by dispersed precipitation of the fine carbide improve the strength of the hot-rolled steel sheet and obtain excellent stretch-flange formability.
2) To obtain a hot-rolled steel sheet with excellent formability and a high strength of a tensile strength of 780 MPa or more, it is necessary to precipitate dispersed, fine carbide where the average particle size effective for precipitation strengthening is less than 10 nm at a desired volume fraction.
3) As the fine carbide that contributes to precipitation strengthening, carbide containing Ti and V is effective from the aspect of achieving strength or similar purpose.
4) To make uniform the formability of hot-rolled steel sheet in the width direction, contents of Ti and V, which form fine carbide, are specified. This is effective in reducing a structural change at an end of the steel sheet in the width direction.
5) To substantially design a matrix in a steel sheet structure as a ferrite single-phase and to precipitate dispersed carbide containing Ti and V of less than 10 nm as described above at a desired volume fraction, it is important to control a coiling temperature during manufacturing the hot-rolled steel sheet to be a predetermined temperature.

Reasons for limiting the structure of the steel sheets will be described.

We provide a hot-rolled steel sheet that has the following structure. The hot-rolled steel sheet has a matrix with an area ratio of a ferrite phase of 95% or more with respect to an overall structure. Fine carbide with average particle size of less than 10 nm containing Ti and V is dispersedly precipitated in the matrix. A volume fraction of the fine carbide with respect to the overall structure is 0.0020 or more. The hot-rolled steel sheet may have a plating layer on the surface of the hot-rolled steel sheet.

Ferrite Phase: The Area Ratio of 95% or More with Respect to the Overall Structure

A ferrite phase is necessary to be formed to maintain formability (stretch-flange formability) of the hot-rolled steel sheet. It is effective to achieve a ferrite phase with a low dislocation density and excellent ductility as the structure of the hot-rolled steel sheet to improve the formability of the hot-rolled steel sheet. In particular, it is preferred to have a ferrite single-phase as the structure of the hot-rolled steel sheet to improve the stretch-flange formability. However, even when the structure of the hot-rolled steel sheet is not a complete ferrite single-phase, it is only necessary to have a substantially ferrite single-phase structure, that is, to have a ferrite phase with an area ratio of 95% or more with respect to the overall structure to sufficiently provide the above-described effects. Accordingly, the area ratio of the ferrite phase with respect to the overall structure is preferably to be 95% or more.

The structure other than the ferrite phase employs cementite, pearlite, a bainite phase, a martensite phase, a retained austenite phase, and a similar phase. The acceptable sum of these phases is area ratio of 5% or less with respect to the overall structure.

### Fine Carbide Containing Ti and V

The carbide containing Ti and V is more likely to be fine carbide with an extremely small average particle size. That increases the strength of the hot-rolled steel sheet by precipitating dispersed fine carbide in the hot-rolled steel sheet, the dispersed fine carbide to be precipitated is preferred to be fine carbide containing Ti and V.

Conventionally, for high strengthening of the steel sheet, use of Ti carbide not containing V is a mainstream. In contrast, our steel sheets feature use of carbide containing V in addition to Ti.

Ti easily forms carbide. Therefore, Ti carbide without V is likely to be coarse and contributes less to high strengthening of the steel sheet. Accordingly, to provide a desired strength (tensile strength: 780 MPa or more) to the steel sheet, adding more Ti and forming Ti carbide are necessary. On the other hand, excessive addition of Ti may cause reduction of formability (stretch-flange formability). This fails to obtain excellent formability applicable to a raw material for underbody components with a complicated cross-sectional shape, or a similar component.

On the other hand, that tendency that V forms carbide is lower than that of Ti. Accordingly, the use of V is effective to reduce coarsening of carbide. Therefore, we employ compound carbide that contains both Ti and V as carbide to be dispersedly precipitated. Fine carbide containing Ti and V does not mean carbide where each individual carbide (i.e., Ti carbide or V carbide) is separately contained in a structure, but compound carbide containing both Ti and V in one fine carbide.

Average Particle Size of Fine Carbide Containing Ti and V: Less than 10 nm

The average particle size of the fine carbide is extremely important to result a desired strength to a hot-rolled steel sheet. One feature is that the average particle size of the fine carbide containing Ti and V is designed to be less than 10 nm.

When the fine carbide is precipitated in the matrix, this fine carbide acts to resist movement of dislocations occurring when the steel sheet is deformed. This action strengthens the hot-rolled steel sheet. The effect becomes remarkable with smaller fine carbide. Designing the average particle size of the fine carbide to less than 10 nm makes the above-described action to be further remarkable. Accordingly, the average particle size of the fine carbide containing Ti and V is preferably to be less than 10 nm, more preferably, 5 nm or less.

Volume Fraction of Fine Carbide Containing Ti and V with Respect to the Overall Structure: 0.0020 or More

To produce a desired strength to the hot-rolled steel sheet, a dispersed precipitation state of the fine carbide containing Ti and V is extremely important. The fine carbide that contains Ti and V with average particle size of less than 10 nm is dispersedly precipitated such that the structural fraction of fine carbide with respect to the overall structure becomes 0.0020 or more in volume fraction. If the volume fraction is less than 0.0020, even if the average particle size of the fine carbide containing Ti and V is less than 10 nm, it is difficult to reliably ensure the desired hot-rolled steel sheet strength. Accordingly, it is preferred that the volume fraction be 0.0020 or more, more preferably, 0.0030 or more.

Although precipitation in rows, which is a main precipitation state, is mixed with random precipitation of the fine carbide as a precipitation state of the fine carbide containing Ti and V, this does not have any influence on the characteristics. Various precipitation states are collectively referred to as “dispersed” precipitation regardless of the state of precipitation.

Next, reasons for limiting the chemical composition of the hot-rolled steel sheets will be described. Hereinafter, “%” used for the chemical composition indicates “mass %,” unless otherwise stated.

C: 0.03% or More to Less than 0.07%

C is a necessary element to form the fine carbide and strengthen the steel. If the C content is less than 0.03%, fine carbide with desired structure fraction cannot be obtained, and a tensile strength of 780 MPa or more cannot be obtained. On the other hand, if the C content is 0.07% or more, the strength is increased too much, formability (stretch-flange formability) deteriorates. Accordingly, the C content is preferably 0.03% or more to less than 0.07%, more preferably, 0.04% or more to 0.05% or less.

### Si: 0.3% or Less

Si is a solid-solution strengthening element and an element effective to strengthen the steel. However, if the Si content exceeds 0.3%, the C precipitation from the ferrite phase is promoted and coarse Fe carbide is likely to precipitate at the grain boundaries. This reduces stretch-flange formability. Additionally, an excessive Si content adversely affects plating performance of the steel sheet. Accordingly, the Si content is preferably 0.3% or less.

### Mn: 0.5% or More to 2.0% or Less

Mn is a solid solution strengthening element and an element effective to strengthen the steel. Mn is also an element that lowers an Ar₃ transformation temperature of a steel. The Ar₃ transformation temperature becomes high if the Mn content is less than 0.5%. Accordingly, the carbide containing Ti is not sufficiently fine-grained and, also, an amount of solid solution strengthening is not enough, thus, failing to obtain a tensile strength of 780 MPa or more. If the Mn content exceeds 2.0%, segregation becomes remarkable and a phase other than the ferrite phase, that is, a hard phase is formed. This reduces stretch-flange formability. Accordingly, the Mn content is preferably 0.5% or more to 2.0% or less, more preferably, 1.0% or more to 1.8% or less.

### P: 0.025% or Less

P is a solid solution strengthening element, and an element effective to strengthen the steel. However, if the P content exceeds 0.025%, segregation becomes remarkable. This reduces stretch-flange formability. Accordingly, the P content is preferably 0.025% or less, more preferably, 0.02% or less.

### S: 0.005% or Less

S is an element that reduces hot workability (hot rolling property) and increases hot crack sensitivity of the slab. Additionally, S is present as MnS in the steel, thus deteriorating formability (the stretch-flange formability) of the hot-rolled steel sheet. S forms TiS in the steel and reduces Ti precipitated as fine carbide. Accordingly, S is preferred to be reduced as much as possible. The S content is preferably 0.005% or less.

### N: 0.0060% or Less

N is a harmful element and is preferred to be reduced as much as possible. In particular, if the N content exceeds 0.0060%, coarse nitride is generated in the steel. This reduces stretch-flange formability. Accordingly, the N content is preferably 0.0060% or less.

### Al: 0.1% or Less

Al is an element acting as a deoxidizer. To obtain this effect, the Al content is preferably 0.001% or more. However, if the Al content exceeds 0.1%, stretch-flange formability is reduced. Therefore, the Al content is preferably Al: 0.1% or less.

### Ti: 0.07% or More to 0.11% or Less

Ti is one of the important elements. Ti is an element that contributes to high strengthening of the steel sheet while obtaining excellent elongation and stretch-flange formability by forming compound carbide with V. A desired strength of the hot-rolled steel sheet cannot be obtained if the Ti content is less than 0.07%. On the other hand, if the Ti content exceeds 0.11%, coarse carbide containing Ti is likely to be precipitated, making the strength of steel sheet unstable. Accordingly, the Ti content is preferably 0.07% or more to 0.11% or less.

V: 0.08% or More to Less than 0.15%

V is one of the important elements. As described above, V is an element that contributes to high strengthening of the steel sheet while obtaining excellent elongation and stretch-flange formability by forming compound carbide with Ti. V is an extremely important element that stably achieves excellent strength of the steel sheet by forming compound carbide with Ti and contributes to material uniformity of the steel sheet. If the V content is less than 0.08%, the strength of steel sheet cannot be sufficiently obtained. On the other hand, if the V content is 0.15% or more, the strength becomes excessively high, resulting in deterioration of formability (stretch-flange formability). Accordingly, the V content is preferably 0.08% or more to less than 0.15%.

The hot-rolled steel sheet contains Ti and V such that Formula (1) is satisfied within the above-described range.

0.18≦Ti+V≦0.24 (1)

(where Ti and V are respective contents of the elements (by mass %)).

The above-described Formula (1) is a condition to be satisfied in providing the steel sheet with stable strength and formability (stretch-flange formability). If a total content of Ti and V becomes less than 0.18%, designing a volume fraction of the fine carbide containing Ti and V with respect to the overall structure to 0.0020 or more is difficult. On the other hand, if the total content of Ti and V exceeds 0.24%, steel sheet strength becomes excessively high, resulting in deterioration of formability (stretch-flange formability). Accordingly, it is preferred that the total content of Ti and V be 0.18% or more to 0.24% or less. Thus, the fine carbide containing Ti and V is generated at a desired volume fraction, stabilizing steel sheet strength and also stabilizing formability (stretch-flange formability).

The compositions described above are basic compositions. In addition to the above-described basic compositions, at least one selected from the group consisting of Nb and Mo can be contained by 1% or less in total. Nb and Mo form compound carbide by composite precipitation together with Ti and V and contribute to obtaining a desired strength. Therefore, Nb and Mo can be contained as necessary. To obtain such an effect, it is preferred that Nb and Mo be contained at 0.005% or more in total. However, since excessively Nb and Mo tends to deteriorate elongation, it is preferred that the total amount of any one or two of Nb and Mo be 1% or less.

In addition to the above-described basic compositions, at least one selected from the group consisting of Cu, Sn, Ni, Ca, Mg, Co, As, Cr, W, B, Pb, Ta, and Sb may be contained by 1% or less in total, more preferably, 0.5% or less. As constituents other than ones described above, Fe and the unavoidable impurities are contained.

A plating layer may be formed at a surface of a hot-rolled steel sheet with the above-described structure and composition. The type of plating layer is not specifically limited. Any conventionally known layer such as an electroplated layer, a hot-dip galvanized layer, and a hot-dip galvannealed layer is applicable.

Next, a description will be given of a method of producing the hot-rolled steel sheets.

Hot rolling that includes rough rolling and finish rolling is performed on the steel material (semi-manufactured steel material). After the finish rolling is terminated, cooling and coiling are performed to obtain a hot-rolled steel sheet. At this time, the finish rolling temperature of the finish rolling is 880° C. or more, the average cooling rate of the cooling from the termination of the finish rolling to the coiling is 10° C./sec. or more, and the coiling temperature is 550° C. or more to less than 700° C. A plating process may be performed on the hot-rolled steel sheet thus obtained.

The method of smelting the semi-manufactured steel material is not specifically limited and can employ a known smelting method using a converter, an electric furnace, or similar furnace. After smelting, in consideration of segregation and similar problem, a slab (semi-manufactured steel material) is preferred to be obtained by a continuous casting method. The slab may be obtained by a known casting method such as an ingot-slab making method and a thin slab continuous casting method. To hot-roll the slab after the casting, the slab may be rolled after being reheated in a heating furnace. The slab may be directly rolled without heating the slab when the temperature is held at a predetermined temperature or more.

Rough rolling and finish rolling are performed on the semi-manufactured steel material obtained as described above. However, it is preferred that carbide be dissolved in the semi-manufactured steel material before rough rolling. When Ti and V, which are carbide-forming elements, are contained, the heating temperature of the semi-manufactured steel material is preferably 1150° C. or more to 1280° C. or less. As described above, when the semi-manufactured steel material before rough rolling is held at a temperature of a predetermined temperature or more and the carbide in the semi-manufactured steel material is dissolved, the process of heating the semi-manufactured steel material before rough rolling can be omitted. It is not necessary to specifically limit the rough rolling conditions.

### Finish Rolling Temperature: 880° C. or More

Controlling the finish rolling temperature is important to improve stretch-flange formability of the hot-rolled steel sheet. A finish rolling temperature of less than 880° C. results in large grains of crystal grains in the surface layer of the hot-rolled steel sheet and deterioration in formability of the steel sheet (stretch-flange formability). Accordingly, the finish rolling temperature is preferably 880° C. or more, more preferably, 900° C. or more. An excessively high finish rolling temperature tends to generate flaws due to secondary scale at the surface of the steel sheet. Thus, the finish rolling temperature is preferably 1000° C. or less.

### Average Cooling Rate: 10° C./Sec. or More

After finish rolling is terminated, an average cooling rate from a finish rolling temperature to the coiling temperature of less than 10° C./sec. results in a high Arₐ transformation temperature. Thus, the carbide containing Ti cannot be sufficiently fine-grained. Accordingly, the above-described average cooling rate is preferably to be 10° C./sec. or more, more preferably, 30° C./sec. or more.

Coiling Temperature: 550° C. or More to Less than 700° C.

Controlling the coiling temperature is extremely important to achieve, as a structure of the hot-rolled steel sheet, a desired structure over the entire region in the width direction of the steel sheet, that is, a matrix in which the area ratio of a ferrite phase is 95% or more with respect to the overall structure and a structure in which fine carbide, which contains Ti and V and has an average particle size of less than 10 nm, is dispersedly precipitated and coarse carbide is reduced.

If the coiling temperature is less than 550° C., precipitation of the fine carbide containing Ti and V becomes insufficient, thereby failing to obtain the desired steel sheet strength. On the other hand, if the coiling temperature becomes 700° C. or more, the average particle size of the fine carbide containing Ti and V is increased. In this case as well, the desired steel sheet strength cannot be obtained. Accordingly, the coiling temperature is preferably 550° C. or more to less than 700° C., more preferably, 600° C. or more to 650° C. or less.

A plating process may be performed on the hot-rolled steel sheet obtained as described above to form a plating layer on a surface of the hot-rolled steel sheet. The type of plating process is not specifically limited. A plating process such as a hot-dip galvannealing process and hot-dip galvannealing process can be performed in accordance with conventionally known methods.

As described above, to produce a high strength hot rolled steel sheet that has a tensile strength of 780 MPa or more, excellent formability (stretch-flange formability) suitable for raw material for automobile components or a similar component with a complicated cross-sectional shape, and uniform and stable material, it is important to dispersedly precipitate the fine carbide containing Ti and V with the average particle size of less than 10 nm over the entire region in the width direction of the steel sheet.

The content of each Ti and V in the steel, which becomes a raw material for the hot-rolled steel sheet, is specified, and the total content of these elements (Ti+V) is specified to 0.18% or more to 0.24% or less. This reduces precipitation of coarse carbide and controls the composition of the fine carbide such that the fine carbide with average particle size of less than 10 nm is sufficiently dispersedly precipitated. Accordingly, in producing a hot-rolled steel sheet, even at an end of the steel sheet in the width direction, where the material is likely to be unstable in a cooling process after completion of finish rolling, the fine carbide with average particle size of less than 10 nm can be sufficiently dispersedly precipitated. That is, we allow dispersed precipitation of the fine carbide with the average particle size of less than 10 nm over the entire region in the width direction of the hot-rolled steel sheet. This provides uniform and excellent characteristics (tensile strength and stretch-flange formability) over the entire region in the width direction of the hot-rolled steel sheet.

### EXAMPLES

Molten steels with compositions shown in Table 1 were smelted and subjected to continuous casting to have slabs (semi-manufactured steel materials) with a thickness of 250 mm by known method. These slabs were heated to 1250° C. and then subjected to rough rolling and finish rolling. After finish rolling was terminated, cooling and coiling were performed to obtain hot-rolled steel sheets with a sheet thickness of 2.3 mm and a sheet width of 1400 mm. The finish rolling temperature at the finish rolling, the average cooling rate at the cooling (the average cooling rate from the finish rolling temperature to the coiling temperature), and the coiling temperature are as shown in Table 2.

Subsequently, some of the hot-rolled sheets obtained as described above (hot-rolling Nos. in Table 2: 3, 9, and 11) were pickled to remove surface scale. Then, an annealing process was performed (annealing temperature: 680° C., holding time at the annealing temperature: 120 sec.). Next, the annealed hot-rolled sheet was dipped in a hot-dip galvanizing bath (plating composition: 0.1% Al-Zn, plating bath temperature: 480° C.). Hot-dip galvanized films with an adhesion amount of 45 g/m² (an adhesion amount of one surface) were formed on both surfaces of the hot-rolled steel sheet. Thus, the hot-dip galvanized steel sheet was formed. Regarding one of the obtained hot-dip galvanized steel sheets (hot-rolling No. in Table 2: 9), an alloying process was performed (an alloying temperature: 520° C.) to form a hot-dip galvannealed steel sheet.

TABLE 1

| | Chemical component (mass %) | | | | | | | | | | | | |
|---|---|---|---|---|---|---|---|---|---|---|---|---|---|
| Steel | C | Si | Mn | P | S | N | Al | Ti | V | Nb, Mo | Others | Ti + V | Remarks |
| a | 0.045 | 0.01 | 1.46 | 0.011 | 0.0008 | 0.0032 | 0.042 | 0.101 | 0.110 | — | — | 0.211 | Example |
| b | 0.041 | 0.02 | 1.26 | 0.011 | 0.0009 | 0.0035 | 0.045 | 0.098 | 0.108 | — | Cu: 0.02 | 0.206 | Example |
| c | 0.049 | 0.01 | 1.28 | 0.012 | 0.0011 | 0.0037 | 0.046 | 0.103 | 0.104 | — | — | 0.207 | Example |
| d | 0.048 | 0.01 | 1.33 | 0.012 | 0.0012 | 0.0031 | 0.048 | 0.099 | 0.105 | — | Ni: 0.01, W: 0.01 | 0.204 | Example |
| e | 0.046 | 0.02 | 1.49 | 0.011 | 0.0008 | 0.0039 | 0.043 | 0.085 | 0.121 | — | Sn: 0.005 | 0.206 | Example |
| f | 0.049 | 0.02 | 1.52 | 0.011 | 0.0007 | 0.0035 | 0.042 | 0.097 | 0.118 | — | — | 0.215 | Example |
| g | 0.037 | 0.03 | 1.56 | 0.012 | 0.0013 | 0.0041 | 0.038 | 0.104 | 0.112 | — | Pb: 0.01, As: 0.01 | 0.216 | Example |
| h | 0.047 | 0.03 | 1.27 | 0.012 | 0.0021 | 0.0033 | 0.055 | 0.106 | 0.117 | Mo: 0.009 | — | 0.223 | Example |
| i | 0.049 | 0.02 | 1.47 | 0.011 | 0.0015 | 0.0032 | 0.036 | 0.103 | 0.108 | — | Co: 0.02, Ta: 0.01 | 0.211 | Example |
| j | 0.036 | 0.01 | 1.30 | 0.011 | 0.0012 | 0.0032 | 0.042 | 0.081 | 0.111 | — | Ca: 0.01 | 0.192 | Example |
| k | 0.039 | 0.01 | 1.29 | 0.010 | 0.0013 | 0.0034 | 0.043 | 0.092 | 0.097 | Nb: 0.005 | Cr: 0.015 | 0.189 | Example |
| l | 0.051 | 0.02 | 1.41 | 0.012 | 0.0009 | 0.0041 | 0.038 | 0.094 | 0.093 | — | B: 0.0007 | 0.187 | Example |
| m | 0.056 | 0.01 | 1.35 | 0.011 | 0.0008 | 0.0042 | 0.039 | 0.091 | 0.142 | — | Mg: 0.01 | 0.233 | Example |
| n | 0.061 | 0.02 | 1.29 | 0.011 | 0.0015 | 0.0028 | 0.041 | 0.087 | 0.121 | Nb: 0.007 | — | 0.208 | Example |
| o | 0.049 | 0.03 | 1.43 | 0.010 | 0.0009 | 0.0036 | 0.046 | 0.084 | 0.114 | — | Sb: 0.01 | 0.198 | Example |
| p | 0.016 | 0.01 | 1.42 | 0.011 | 0.0007 | 0.0034 | 0.034 | 0.109 | 0.112 | — | — | 0.221 | Comparative Example |
| q | 0.045 | 0.01 | 1.52 | 0.012 | 0.0009 | 0.0035 | 0.042 | 0.042 | 0.072 | — | — | 0.114 | Comparative Example |
| r | 0.121 | 0.01 | 1.34 | 0.012 | 0.0009 | 0.0035 | 0.030 | 0.163 | 0.224 | — | — | 0.387 | Comparative Example |
| s | 0.040 | 0.01 | 0.34 | 0.010 | 0.0015 | 0.0040 | 0.030 | 0.105 | 0.120 | — | — | 0.225 | Comparative Example |

TABLE 2

| | | Producing conditions of | | | |
|---|---|---|---|---|---|
| | | hot-rolled steel sheet | | | |
| | | Finish | Average | | |
| | | rolling | cooling | Coiling | |
| | Hot- | temper- | rate | temper- | |
| | rolling | ature | (° C./ | ature | |
| Steel | No. | (° C.) | sec.)*1 | (° C.) | Remarks |
| a | 1 | 912 | 25 | 610 | Example |
| | 2 | 879 | 30 | 620 | Comparative Example |
| b | 3 | 903 | 20 | 624 | Example (plated sheet*2) |
| | 4 | 911 | 5 | 630 | Comparative Example |
| c | 5 | 912 | 20 | 628 | Example |
| | 6 | 923 | 25 | 780 | Comparative Example |
| d | 7 | 925 | 25 | 650 | Example |
| | 8 | 918 | 30 | 480 | Comparative Example |
| e | 9 | 924 | 40 | 645 | Example (plated sheet*3) |
| f | 10 | 921 | 30 | 630 | Example |
| g | 11 | 897 | 30 | 628 | Example (plated sheet*4) |
| h | 12 | 912 | 35 | 609 | Example |
| i | 13 | 932 | 35 | 598 | Example |
| j | 14 | 930 | 35 | 675 | Example |
| k | 15 | 912 | 20 | 646 | Example |
| l | 16 | 916 | 25 | 632 | Example |
| m | 17 | 914 | 25 | 623 | Example |
| n | 18 | 915 | 25 | 615 | Example |
| o | 19 | 921 | 30 | 631 | Example |
| p | 20 | 922 | 30 | 628 | Comparative Example |
| q | 21 | 907 | 25 | 625 | Comparative Example |
| r | 22 | 906 | 30 | 620 | Comparative Example |
| s | 23 | 911 | 40 | 630 | Comparative Example |

*1Average cooling rate from finish rolling temperature to coiling temperature (° C./sec.)
*2Hot-dip galvanized steel sheet
*3Hot-dip galvannealed steel sheet
*4Hot-dip galvanized steel sheet

Specimens were extracted from the hot-rolled steel sheets (the hot-rolled steel sheets, hot-dip galvanized steel sheets, or the hot-dip galvannealed steel sheets) obtained as described above. Subsequently, a structure observation, a precipitation observation, a tensile test, and a hole expanding test were carried out to obtain an area ratio of ferrite phase, an average particle size and a volume fraction of the fine carbide containing Ti and V, a tensile strength and a hole expansion ratio (stretch-flange formability). The testing methods were as follows.

### (i) Structure Observation

A specimen was extracted from the obtained hot-rolled steel sheets. The cross section of the specimen in the rolling direction was mechanically polished and etched with nital. Subsequently, a structure photograph (a SEM photograph) taken with a scanning electron microscope (SEM) at a magnification of 3000 times was used to determine the ferrite phase, the type of structure other than the ferrite phase, and the area ratios of these structures by an image analysis device.

### (ii) Precipitation Observation

The thin film produced from the obtained hot-rolled steel sheet (at the position of center of sheet thickness) was observed through a transmission type electron microscope (TEM) at a magnification of 260000 times, to obtain an average particle size and a volume fraction of the fine carbide containing Ti and V.

Regarding the particle size of the fine carbide containing Ti and V, individual particle areas were obtained by image processing based on the observation result of 30 visual fields at a magnification of 260000 times, and the particle sizes were obtained using circular approximation. Subsequently, the arithmetic mean of the particle sizes of each obtained particle was obtained as the average particle size.

Regarding the volume fraction of the fine carbide containing Ti and V, 10% acetylacetone-1% tetramethylammonium chloride-methanol solution (AA solution) was used to electrolyze a base iron. Subsequently, an extracted residue analysis was performed on filtrated residue to obtain the weight of the carbide containing Ti and V. The obtained weight was divided by a density of the carbide containing Ti and V to obtain the volume. This volume was divided by the volume of the dissolved base iron to obtain the volume fraction.

Regarding the density of the carbide containing Ti and V, density of TiC (4.25 g/cm³) was corrected assuming that a part of Ti atom in TiC crystal was replaced by V atom. The density was thus obtained. That is, Ti and V in carbide containing Ti and V were measured by extracted residue analysis and a proportion of V replacing Ti was obtained. Thus, correction was performed considering atomic weights of Ti and V.

(iii) Tensile Test

From the center position and the one-quarter width position in the sheet width of the obtained hot-rolled steel sheets, JIS No. 5 tensile test specimens (JIS Z 2201) were extracted such that the tensile direction was perpendicular to the rolling direction. Subsequently, a tensile test was performed in compliance with the specification of JIS Z 2241 to measure a tensile strength (TS).

### (iv) Hole Expanding Test

From the center position and the one-quarter width position in the sheet width of the obtained hot-rolled steel sheets, a specimen (in the size of 130 mm×130 mm) was extracted. In the specimen, a hole with an initial diameter dₒ of 10 mm φ was formed by punching processing with a punch. The hole expanding test was carried out using these specimens. A conical punch at a vertex angle of 60° was inserted into the hole to expand the hole.

When a crack passed through the steel sheet (the specimen), a diameter “d” of the hole was measured to calculate a hole expansion ratio λ (%) with the following formula:

Hole expansion ratio λ (%)={(d−d₀)/d₀}×100.

The obtained result was shown in Table 3.

TABLE 3

| | | Structure of hot-rolled steel sheet | | | | Mechanical characteristics of hot-rolled steel sheet | | | | |
|---|---|---|---|---|---|---|---|---|---|---|
| | | | | Fine carbide containing | | Tensile strength | | Hole expansion | | |
| | | | Area ratio | Ti and V | | TS (MPa) | | ratio λ (%) | | |
| | Hot- | | of ferrite | Average | | Width | One-quarter | Width | One-quarter | |
| | rolling | | phase | article | Volume | center | width | center | width | |
| Steel | No. | Type*5 | (%)*6 | size (nm) | fraction | portion | position | portion | position | Remarks |
| a | 1 | F | 100 | 5 | 0.0027 | 812 | 810 | 86 | 87 | Example |
| | 2 | F | 100 | 8 | 0.0027 | 793 | 790 | 55 | 58 | Comparative Example |
| b | 3 | F | 100 | 4 | 0.0025 | 796 | 795 | 85 | 87 | Example (plated sheet*2) |
| | 4 | F | 100 | 19 | 0.0025 | 724 | 708 | 89 | 91 | Comparative Example |
| c | 5 | F | 100 | 3 | 0.0029 | 806 | 799 | 87 | 89 | Example |
| | 6 | F | 100 | 23 | 0.0029 | 698 | 675 | 82 | 99 | Comparative Example |
| d | 7 | F | 100 | 5 | 0.0029 | 806 | 800 | 78 | 80 | Example |
| | 8 | F + B | 96 | 5 | 0.0008 | 687 | 678 | 97 | 99 | Comparative Example |
| e | 9 | F | 100 | 6 | 0.0028 | 812 | 801 | 92 | 97 | Example (plated sheet*3) |
| f | 10 | F + P | 97 | 5 | 0.0029 | 805 | 804 | 79 | 81 | Example |
| g | 11 | F | 100 | 5 | 0.0022 | 798 | 792 | 75 | 78 | Example (plated sheet*4) |
| h | 12 | F | 100 | 4 | 0.0028 | 811 | 799 | 86 | 88 | Example |
| i | 13 | F | 100 | 5 | 0.0029 | 802 | 800 | 85 | 86 | Example |
| j | 14 | F | 100 | 6 | 0.0022 | 798 | 789 | 89 | 91 | Example |
| k | 15 | F | 100 | 7 | 0.0023 | 800 | 799 | 84 | 92 | Example |
| l | 16 | F | 100 | 5 | 0.0031 | 812 | 807 | 86 | 88 | Example |
| m | 17 | F | 100 | 5 | 0.0034 | 823 | 817 | 85 | 91 | Example |
| n | 18 | F | 100 | 5 | 0.0037 | 827 | 822 | 82 | 87 | Example |
| o | 19 | F | 100 | 4 | 0.0029 | 803 | 790 | 89 | 95 | Example |
| p | 20 | F | 100 | 3 | 0.0007 | 645 | 638 | 107 | 112 | Comparative Example |
| q | 21 | F | 100 | 3 | 0.0017 | 675 | 666 | 99 | 102 | Comparative Example |
| r | 22 | F + P | 93 | 4 | 0.0073 | 912 | 896 | 54 | 55 | Comparative Example |
| s | 23 | F | 100 | 18 | 0.0024 | 735 | 718 | 85 | 87 | Comparative Example |

*2Hot-dip galvanized steel sheet
*3Hot-dip galvannealed steel sheet
*4Hot-dip galvanized steel sheet
*5F denotes ferrite, P denotes pearlite, and B denotes bainite.
*6Area ratio of ferrite phase with respect to overall structure (%)

All our Examples are hot-rolled steel sheets having both a high strength at a tensile strength of 780 MPa or more and an excellent formability of a hole expansion ratio of λ: 60% or more, thus exhibiting excellent mechanical characteristics. Moreover, all our Examples are hot-rolled steel sheets that meet: a difference in strength between the center of the sheet width (a center portion) and a one-quarter width position of steel sheet is 15 MPa or less, a difference in hole expansion ratio between the center of the sheet width (the center portion) and the one-quarter width position of steel sheet is 15% or less. Thus, stability of the mechanical characteristics and material uniformity are demonstrated.

On the other hand, the hot-rolled steel sheets of the Comparative Examples cannot achieve a desired tensile strength or a hole expansion ratio, or a difference in material in the steel sheet width direction is large.

1. A high strength hot rolled steel sheet, comprising:
a chemical composition comprising:
C: 0.03% or more to less than 0.07%;
Si: 0.3% or less;
Mn: 0.5% or more to 2.0% or less;
P: 0.025% or less;
S: 0.005% or less;
N: 0.0060% or less;
Al: 0.1% or less;
Ti: 0.07% or more to 0.11% or less; and
V: 0.08% or more to less than 0.15% on a mass percent basis, such that Ti and V contents satisfy Formula (1):
0.18≦Ti+V≦0.24 (1)
(where Ti and V are respective contents of the elements (by mass %)),
the balance comprising Fe and inevitable impurities,
a matrix having a ferrite phase with an area ratio of 95% or more with respect to an overall structure; and
a structure where fine carbide is dispersedly precipitated in the matrix, the fine carbide containing Ti and V has an average particle size of less than 10 nm, and a volume fraction of the fine carbide is 0.0020 or more with respect to the overall structure,
wherein the high strength hot rolled steel sheet has a tensile strength of 780 MPa or more.

2. The high strength hot rolled steel sheet according to claim 1, wherein
the chemical composition further contains at least one selected from the group consisting of Nb and Mo by 1% or less in total on a mass percent basis.

3. The high strength hot rolled steel sheet according to claim 1, wherein
the chemical composition further contains at least one selected from the group consisting of Cu, Sn, Ni, Ca, Mg, Co, As, Cr, W, B, Pb, Ta, and Sb by 1% or less in total on a mass percent basis.

4. The high strength hot rolled steel sheet according to claim 2, wherein
the chemical composition further contains at least one selected from the group consisting of Cu, Sn, Ni, Ca, Mg, Co, As, Cr, W, B, Pb, Ta, and Sb by 1% or less in total on a mass percent basis.

5. The high strength hot rolled steel sheet according to claim 1, further comprising
a plating layer formed at a surface of the high strength hot rolled steel sheet.

6. The high strength hot rolled steel sheet according to claim 1, wherein
the high strength hot rolled steel sheet has a hole expansion ratio of 60% or more.

7. The high strength hot rolled steel sheet according to claim 6, wherein
a difference in a tensile strength between a center portion of a sheet width and a position at one-quarter width of the steel sheet is 15 MPa or less, and a difference in a hole expansion ratio among the positions is 15% or less.

8. A method of producing a high strength hot rolled steel sheet comprising:
preparing the steel material with the chemical composition according to claim 1;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.

9. The method according to claim 8, further comprising
plating a surface of the hot-rolled steel sheet subsequent to the coiling.

10. The high strength hot rolled steel sheet according to claim 2, further comprising
a plating layer formed at a surface of the high strength hot rolled steel sheet.

11. The high strength hot rolled steel sheet according to claim 3, further comprising
a plating layer formed at a surface of the high strength hot rolled steel sheet.

12. The high strength hot rolled steel sheet according to claim 4, further comprising
a plating layer formed at a surface of the high strength hot rolled steel sheet.

13. The high strength hot rolled steel sheet according to claim 2, wherein
the high strength hot rolled steel sheet has a hole expansion ratio of 60% or more.

14. The high strength hot rolled steel sheet according to claim 3, wherein
the high strength hot rolled steel sheet has a hole expansion ratio of 60% or more.

15. The high strength hot rolled steel sheet according to claim 4, wherein
the high strength hot rolled steel sheet has a hole expansion ratio of 60% or more.

16. A method of producing a high strength hot rolled steel sheet comprising:
preparing the steel material with the chemical composition according to claim 2;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.

17. A method of producing a high strength hot rolled steel sheet comprising:
preparing the steel material with the chemical composition according to claim 3;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.

18. A method of producing a high strength hot rolled steel sheet comprising:
preparing the steel material with the chemical composition according to claim 4;
hot-rolling the steel material including rough rolling and finish rolling at a rolling temperature of 880° C. or more to form a hot-rolled steel sheet;
cooling the hot-rolled steel sheet at an average cooling rate of 10° C./sec. or more subsequent to completion of the finish rolling; and
coiling the hot-rolled steel sheet at 550° C. or more to less than 700° C.
